(19) United States
(12) Patent Application Publication
(10) Pub. No.: US 2026/0252741 A1
(43) Pub. Date: Aug. 27, 2026

(54) SHARED CONTEXTS OF APPLETS LOADED ONTO A DATA CARRIER

(71) Applicant: GIESECKE+DEVRIENT EPAYMENTS GMBH, Munchen (DE)

(72) Inventors: Thomas STOCKER, Munchen (DE); Ingeborg FLADÉE, Munchen (DE); Jorn TREGER, Rosenheim (DE)

(21) Appl. No.: 18/877,430

(22) PCT Filed: Jun. 19, 2023
(86) PCT No.: PCT/DE2023/100459

§ 371 Date: Dec. 20, 2024

(30) Foreign Application Priority Data
Jun. 21, 2022 (DE) 10 2022 002 247.8

(51) Int. Cl. G06F 21/77; G06F 9/455

(52) U.S. Cl. CPC G06F 21/77; G06F 9/45504

(57) ABSTRACT

Methods and an interface are used to implement shared contexts between a plurality of applets in a Java Card data carrier with a Java Card runtime environment and a storage device. In a server applet, a shared interface is implemented, allowing a client applet to join a context of the server applet. The server applet receives a request from the client applet via the shared interface to join the context of the server applet. In response thereto, the server applet instructs the Java Card runtime environment to integrate the client applet into the context of the server applet.

The present invention relates generally to the handling of contexts and applets for Java Card applications on smartcards and in particular to illustrative embodiments for implementing contexts shared by a plurality of applets that are loaded into a smartcard.

### BACKGROUND OF THE INVENTION

Smartcards and comparable data carriers are used worldwide in a large number of applications. A smartcard is a card-shaped data carrier containing an embedded integrated circuit (IC), often referred to as a chip or microprocessor. It is used in the form of credit and debit cards, transport cards, SIM cards, ID and identity cards and the like. The embedded IC is used for data storage, additional security and other functionalities of the smartcard.

Java Card technology (“Java Card” for short) was introduced in order to be able to execute programs written in the programming language Java on chip cards and other small, limited-resource data carriers.

Due to the limited resources on smartcards, Java Card provides an operating system that comprises a slimmed-down version of the virtual machine customary for Java, known as the Java Card virtual machine (JCVM). An implementation of the JCVM together with API classes of Java Card is provided by the Java Card runtime environment (JCRE). The JCRE makes additional demands on the runtime security of such data carriers that implement the JCRE. One such security requirement is the isolation of applets and the joint use of shared objects. This basic function enforced by the JCRE in respect of runtime security causes applets to be isolated using what is known as an applet firewall. The applet firewall prevents objects created by one applet from being able to be used by another applet. Essentially, these firewalls divide the JCRE object system into separate, protected object areas referred to as contexts. This prevents unauthorized access to data and methods of class instances.

The current implementation of the Java Card runtime environment, JCRE, supports the isolation of contexts and applets. FIG. 1 shows the object system 10 of the Java Card platform with multiple contexts 12, 16, which are stored within the applet area and isolated from one another by the firewall 2. The applets 14, 14′, 18 and 18′ are stored in their respective context. Applets that belong to the same context are stored in the same compressed applet, or the relevant CAP file. An applet instance A1, identified by the reference sign 14, can freely access objects that belong to the applet instance A2, 14′, which is located in an arbitrary package within the same Java Card CAP file A. To access objects in another context, however, additional mechanisms are required. The JCRE keeps its own JCRE context 11 to store special system privileges. The context 11 of the JCRE is separated from the applet area by the firewall 4.

The isolation of applets requires a mechanism that permits applets to jointly use objects, i.e. to share the objects, in situations in which interoperability is required. The JCRE implements the sharing of objects, that is to say the joint use thereof by different applets, through the concepts of the shared, or shareable, interface and the shared, or shareable, interface objects. A shared interface defines a series of shared, or shareable, methods within the interface. These interface methods can be called from a context even if the object implementing them is in possession of an applet in another context. An object instance of a class that implements a jointly usable, or shared, interface is referred to as a shareable interface object (SIO).

FIG. 2 illustrates the sharing of objects, that is to say the provision thereof for joint use by different applets via a shared interface as implemented in the JCRE, for instance. If context 1 is the active context and a method m1 in an object that is associated with the applet A1 is called, no change of context takes place. If the method m1 calls—by way of a method call (0)—a method m2 in an object that is associated with the applet A2, similarly no change of context occurs and no firewall restrictions apply. If the method m2 calls a method m0 in an object that is associated with the applet B1, however, then firewall restrictions apply and, if access is permitted, a change of context (i) occurs. The return to the method m2 from the method m0 results in the context of the applet A2 being restored (ii). Both the change of context and the restoration of the context are implemented via the shared interface. In particular, the applet B1 needs to implement an SIO in its context 2 in order to make its objects available to share with the applet A2 in context 1. If the applet A2 wants to access the applet B1 (i.e. if the method m2 calls the method m0), the applet A2 calls the SIO via the shared interface that has been set up, and the change of context is then performed by the JCVM. A similar method is implemented for restoration of the context after the return to m2.

Although the context switching via shared interfaces provides a secure mechanism for the communication between the applets, it has several weaknesses. A shared interface is a permanent bridge between two contexts and must be used every time an interaction is implemented between applets within different contexts. Access to objects via a shared interface therefore has significant effects on performance and space requirement.

The provision of modular extensions at runtime, e.g. the extension of the UICC file system, requires access to existing objects. The extension must therefore be in the same context. For applets of different CAP files, which thus belong to different contexts, a modular extension of the code at runtime is therefore difficult to accomplish.

When personalizing smartcards, the usual solution amounts to loading the target code into a first context of the chip card via a first package, while the personalization code is loaded via a second package and installed in a second context. Some applets have a considerable space requirement in the personalization code used once. To release the personalization code following personalization, it could be relocated to additional CAP files and then erased. The personalization code must then be in the same context as the target code.

Moreover, what is known as “patching” requires a certain time in order to adapt the data and/or structure of existing objects. In this respect, the patching of code could be facilitated if the patching code belongs to the same context as the objects to be changed.

It is therefore the object of the present invention to propose a solution for the aforementioned disadvantages.

### SUMMARY OF THE INVENTION

The present invention achieves the aforementioned object by way of the subjects specified in the independent claims. Preferred embodiments of the invention are defined in the dependent claims.

According to a first aspect of the present invention, a method for implementing a context shared between a plurality of applets in a Java Card data carrier is provided, the Java Card data carrier comprising a Java Card runtime environment (JCRE) and a storage device, wherein at least a first or server applet of the plurality of applets is installed in a first context in the storage device. The method is carried out in regard to the first or server applet. In a first step, the server applet implements a shared interface in order to permit a second or client applet to join the context of the server applet. In a further step, the server applet receives a request to join the context of the server applet from the client applet via the shared interface. The server applet then instructs the JCRE to integrate the client applet into the context of the server applet.

Implementation of the context sharing method permanently integrates an applet or Java code into the context of another applet or Java code, i.e. it is installed therein or transferred thereto. All objects of the applets within the context are therefore comprehensively accessible to each applet in this context. This overcomes the restriction that objects of different applets have hitherto been able to be accessed only via dedicated, shared interfaces. According to the invention, the shared contexts permit efficient implementation of applet extensions at runtime and the erasure of applets. Further, inter-applet communication, that is to say communication between applets, is improved, while storage requirement is reduced.

According to some embodiments of the present invention, the shared interface is implemented as a public interface that defines a set of methods that are shared between the contexts, or jointly used by said contexts. In particular, a join context method is defined that allows other applets from the plurality of applets to request to join the context of the server applet.

Preferably, the server applet receives the request to join the context of the server applet by way of the call to the method, which is parameterized with an applet object of the client applet.

An efficient way of implementing a change of context (context switch) is permitted by the public interface defined by the server applet.

According to some embodiments of the present invention, the method according to the first aspect comprises carrying out a security check at the server applet to check the admissibility of the join context request.

Preferably, the security check involves checking whether a client applet identifier corresponding to the applet object received by way of the call to the join context method is held in a list of expected or admissible applet identifiers, the AIDs.

By way of example, the list of expected or admissible AIDs can identify those applets that have been selected for participation in the inter-applet communication. An applet that is not approved for the inter-applet communication cannot join the context.

Security can be increased by way of additional checks, for instance by verifying the requesting applet against other applets that are already present in the context that is to be joined.

In some embodiments of the present invention, the server applet instructs the JCRE to integrate the client applet into its own context by sending a share context notification to the JCRE. This share context notification is used by the JCRE to initiate joint use of the context.

Preferably, the share context notification is implemented as a system API method that obtains the client applet as input and returns “TRUE” or a comparable value, or a value having comparable significance, if the join context request is admissible. Otherwise, “FALSE” or a comparable value, or a value having comparable significance, is returned.

According to some embodiments of the present invention, an instance of the shared interface via which the server applet has received the join context request from the client applet is erased after integration of the client applet into the context of the server applet.

As the instance of the shared interface is needed only to obtain the object reference of the client applet, it can be removed following integration into the context of the server applet, thereby reducing the storage requirement of the server applet.

According to a second aspect of the present invention, a method for implementing a context shared between a plurality of applets in a Java Card data carrier is provided, the Java Card data carrier comprising a Java Card runtime environment (JCRE) and a storage device, wherein at least a first or server applet of the plurality of applets is installed in a first context in the storage device. The method is carried out in regard to a client applet and comprises, in a first step, setting up a communication with the server applet via a shared interface that is provided by the server applet. In a subsequent step, a join context request is sent to the server applet in order to join the context of the server applet.

According to some embodiments of the present invention, setup of the communication with the server applet is implemented by the client applet by virtue of a join context notification being sent to the JCRE, indicating the server applet whose context the client applet is supposed to be joining. This join context notification is used to communicate, or confirm, to the JCRE the desire, or readiness, of the client applet to join the context of the server applet. Preferably, the join context notification is implemented by the client applet as a call to the method JCSystem.getAppletShareableInterfaceObject(AID serverAID), the parameter serverAID identifying the server applet.

Preferably, on or after obtaining the shared interface, that is to say the SIO of the server applet, the client applet sends the request to join the context of the server applet by calling a method that the server applet provides via the shared interface.

According to a third aspect, a method for implementing a context shared between a plurality of applets in a Java Card data carrier is provided, the Java Card data carrier comprising a Java Card runtime environment (JCRE) and a storage device, wherein at least a first or server applet of the plurality of applets is installed in a context in the storage device. The method is carried out in regard to the JCRE. In a first step, a join context notification is received from a second or client applet, which notification indicates an applet identifier, AID, of a first applet installed in a first context. In further steps, a share context notification is received from the first or server applet, and the second or client applet is installed in the first context if the share context notification has the value “TRUE” or a comparable value, or a value having comparable significance.

According to some embodiments according to the third aspect of the present invention, the JCRE installs the second applet in a context of its own, or the second applet remains in its own context, if the received share context notification has the value “FALSE” or a comparable value, or a value having comparable significance.

According to some embodiments, the context can be joined during installation of the second applet or later at the time of execution.

According to a further aspect, a shared interface is provided that defines a set of shared methods that a server applet renders accessible to a client applet of a plurality of applets that are loaded in a Java Card data carrier in order to implement an inter-applet communication. The shared interface defines a method to be called by the client applet, said method being parameterized with an applet object of the client applet.

This interface permits the implementation of contexts that are shared, or can be shared, between the applets of a Java Card data carrier after being loaded.

According to a further aspect, a computer program product is provided that comprises a set of instructions for performing the following steps: loading a first package, which comprises a first applet, onto a Java Card data carrier, the Java Card data carrier comprising a Java Card runtime environment (JCRE) and a storage device; installing the first applet in a first context in the storage device of the Java Card data carrier; loading a second package, which comprises a second applet, onto the Java Card data carrier; performing the steps according to an arbitrary embodiment of the first aspect of the present invention in regard to the first or server applet; performing the steps according to an arbitrary embodiment of the second aspect of the present invention in regard to the second or client applet; and performing the steps according to an arbitrary embodiment of the third aspect of the present invention in regard to the JCRE.

Further aspects, features and advantages of the present invention will become clear to a person skilled in the art on studying the detailed description of preferred embodiments and variants of the present invention that follows in combination with the appended figures.

### BRIEF DESCRIPTION OF THE DRAWINGS

Reference is now made to the appended figures, in which:

FIG. 1 shows a schematic representation of contexts within the object system of a Java Card platform;

FIG. 2 shows a schematic representation of a change of context and access to an object as are conventionally implemented in the object system of the Java Card platform according to FIG. 1;

FIG. 3 shows a schematic representation of shared contexts implemented on the object system of the Java Card platform according to an embodiment of the invention;

FIG. 4 shows a flow and signal diagram illustrating function calls for implementing the context sharing according to an embodiment of the invention;

FIG. 5 shows a flowchart for the method according to FIG. 4 as is implemented in regard to a server applet according to an embodiment of the invention;

FIG. 6 shows a flowchart for the method according to FIG. 4 as is implemented in regard to a client applet according to an embodiment of the invention; and

FIG. 7 shows a flowchart for the method according to FIG. 4 as is implemented in regard to the Java Card runtime environment according to an embodiment of the invention.

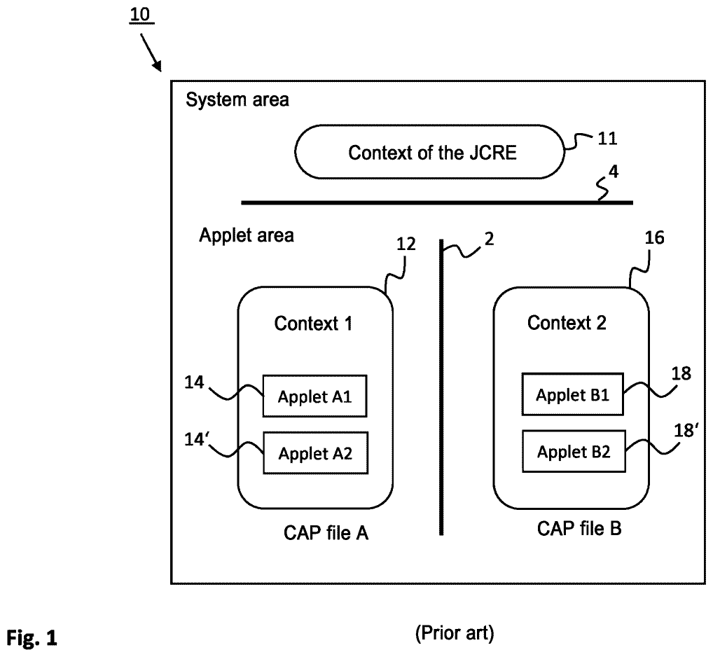

### DETAILED DESCRIPTION

The present invention is explained in detail below with reference to the appended drawings. These show specific exemplary embodiments of the present invention. These exemplary embodiments are described in such detail that a person skilled in the art is able to carry out the invention. It goes without saying that the various embodiments of the present invention are not mutually exclusive, even though they are fundamentally different. As such, for example a specific feature, a specific structure or a specific property that is described in connection with one embodiment can be implemented in other embodiments without this requiring a departure from the scope of application and protection of the present invention. Moreover, it also goes without saying that the position or the arrangement of individual elements within each disclosed embodiment can be modified without this leading to a departure from the scope of application or protection of the present invention. The detailed description that follows should therefore not be understood in a limiting sense and the scope of the present invention is defined only by the appended claims, which should be interpreted in light of all equivalents that arise from them and the present description. In the drawings, identical reference signs refer to identical or similar functionalities in the different views.

In particular, the present invention and the embodiments and alternative embodiments described hereinbelow can be implemented in the form of software on the Java Card platform, or within a Java Card data carrier. The configuration of the methods and subjects of the present invention as installable and/or executable software is therefore part of the scope of application or protection of the present invention.

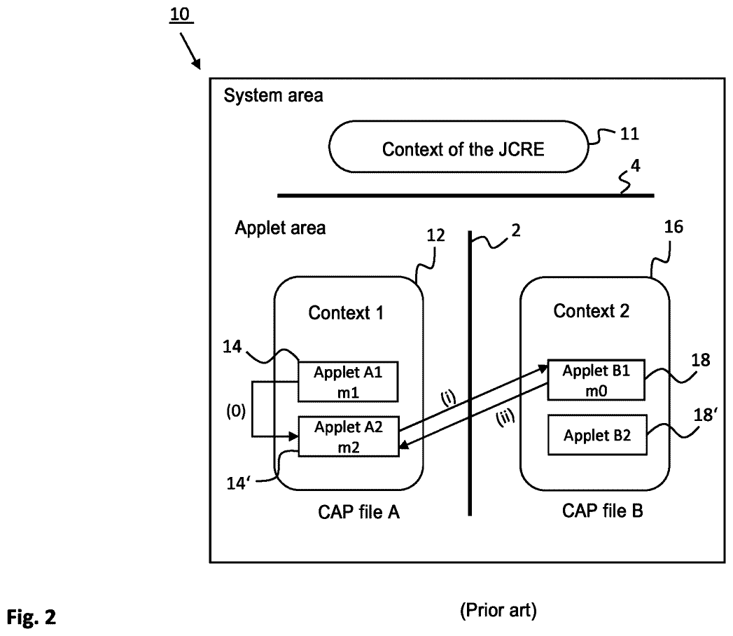

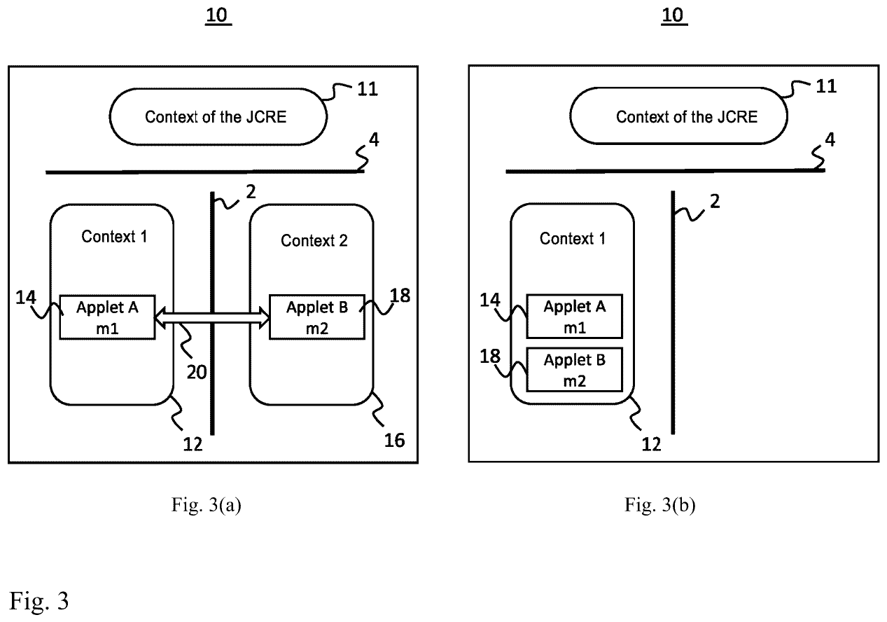

In line with FIG. 2, FIG. 3 shows the object system 10 of the Java Card platform that implements the methods according to the embodiments of the present invention. In particular, two views of the system are depicted, specifically firstly FIG. 3(a), which shows the state of the object system 10 of the Java Card platform before context sharing, and secondly FIG. 3(b), which shows the state of the object system 10 of the Java Card platform after the implementation of context sharing according to embodiments of the present invention.

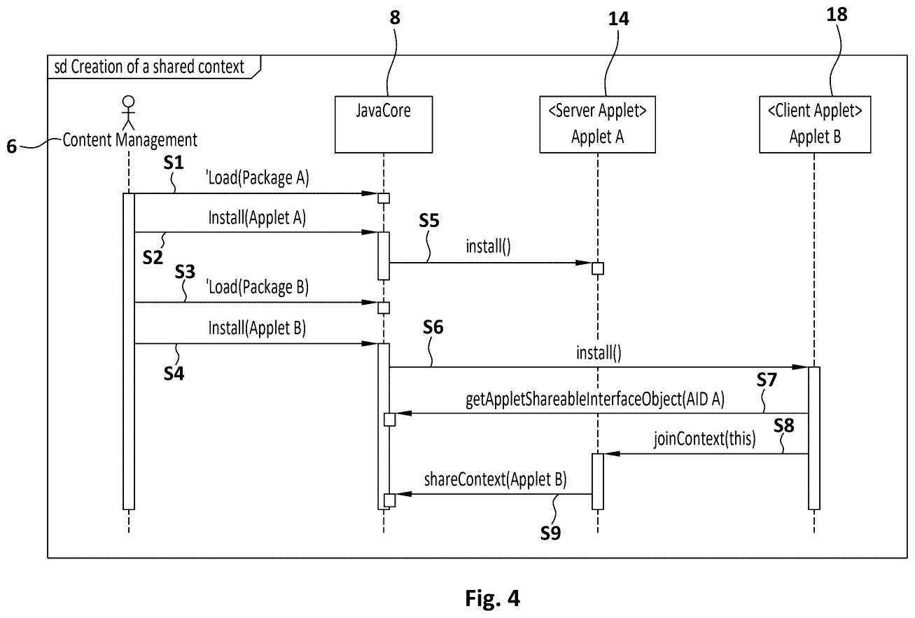

Referring to FIG. 3(a), the applet area is split into two contexts, namely into context 1, identified by the reference sign 12, and context 2, identified by the reference sign 16. An applet A 14 is stored in the context 1, while an applet B 18 is stored in the context 2. The method m1 belongs to an object that is associated with applet A. The method m2 belongs to an object that is associated with applet B. Further, a jointly usable, or shared, interface 20 is depicted between applet A and applet B. In the embodiment in FIG. 3, the shared interface is implemented by the applet A, while applet B uses the shared interface 20 to request to join the context of applet A. To this end, applet B calls specific methods, which are provided via the shared interface 20, as described later on with reference to FIGS. 4 and 5.

As depicted in FIG. 3(b), on or after implementing context sharing, applet A shares its context with applet B 18, that is to say that applet B is integrated into the context 1 and therefore no longer belongs to its original context, the context 2 in FIG. 3(a). All objects of both applets A and B are therefore jointly used, or shared, and are completely accessible to each applet.

FIG. 3(b) shows the state of the object system 10 of the Java Card platform after context sharing has been implemented. The original context 2 of the applet B has been erased and removed from the applet area. This releases storage space. Moreover, the shared interface 20 can also be erased, as it is needed only for initially acquiring the object reference of the SIO provided by applet A. There is therefore no need to maintain the shared interface on an ongoing basis, as is required with conventional solutions.

Embodiments of the proposed method for implementing context sharing of loaded applets are described hereinbelow with reference to FIGS. 4 to 7.

The general concept of the present invention is to implement what is known as post load sharing, i.e. the possibility of transferring an existing context generated by a first CAP file in the past to a second CAP file that is loaded/installed later. FIG. 4 shows a flow and signal diagram that shows function calls for implementing this post load sharing of contexts.

In a first step S1, the Java core 8 (JavaCore; part of the JCRE) receives a function or method call from a content management unit 6, said call being used to provide instruction to load a package, or a CAP file, containing an applet A. In step S2, a function or method call instructs the Java core 8 to install the applet A.

The applicable context, which has been generated by a first CAP file (package A), is then extended by a second package B, which the Java core 8 receives from the content management unit 6 in step S3 and which is loaded into the JCRE in step S4 and installed in step S6. Preferably, the applet B is installed in its own context.

Applet B is the client applet 18 and wants to join the context of the server applet A 14. For this purpose, the client applet B needs to set up a communication with the server applet A in order to obtain the SIO thereof. This is done via the shared interface 20 (cf. FIG. 3(a)) implemented by applet A. Details relating to the implementation method for applet A are explained later on with reference to FIG. 5.

In order to communicate with the server applet 16, the client applet 18 can call the method getAppletShareableInterfaceObject(AID A) in step S7. This is a method that is held in the class JCSystem of the JCRE, or the Java core, and that is called by a client applet in order to communicate with a server applet. The method is called using the applet identifier AID of the server applet and returns the SIO of the server applet.

In step S8, the client applet 18 calls a method joinContext(Applet applet) that indicates the applet object that the client applet wants to join. In the illustrative embodiment according to FIG. 4, the applet 18 can call the method joinContext(A). The method can be carried out by applet A 14, and applet B 18 is then added to the context of applet A in step S9 by means of a method call shareContext(Applet B).

An embodiment, as implemented by the server applet, of the above-described method for implementing a shared context is described hereinbelow with reference to FIG. 5.

If the server applet shares, or wants to share, its context for joint use, it needs to implement a shared, or shareable, interface, e.g. the shared interface 20 according to FIG. 3. This is done in step S11 of FIG. 5.

A preferred implementation of the shared interface according to one embodiment is as follows:

| /** | |
|---|---|
| * | Example of an interface, to be implemented by applets |
| * | that want to share their context with another applet. |
| */ | |
| public interface SharedContext extends Shareable { | |
| | /** |
| | * Is called by the client in order to join the |
| | * context of this applet. |
| | * |
| | * @param applet Applet |
| | * Object that wants to join the context. |
| | */ |
| | void joinContext(Applet applet); |
| } | |

Preferably, the shared interface is implemented as a public interface that defines a set of methods that are shared by contexts. In particular, a method joinContext is defined that other applets from the plurality of applets can use to request to join the context of the server applet.

Preferably, other applets send join context requests to the server applet via instances of the shared interface.

Preferably, the server applet implements the method getShareableInterfaceObject(clientAID, byte). The method can be called by the JCRE in order to convey between the client applet requesting use of an object of another applet and the server applet that the object thereof is available for shared use.

In step S12, the server applet 14 receives from the client applet 18, via the method call joinContext(Applet B), a request to join the context of the server applet. The server applet calls the applicable applet entry via the forwarded AID and calls a share context notification in step S14, specifically preferably using the shareContext system API method provided in the class AppletEntry, in order to instruct the JCRE to integrate the client applet into the server context.

/**
* Shares the context with the indicated applet.
*
* @param applet Applet object of the applet
* that wants to join
* @return true if release was successful,
* otherwise false
*/
public native boolean shareContext(Applet applet);

A preferred implementation of the server applet can have the following appearance:

```
void joinContext(Applet applet) {
  // Perform security checks to ascertain whether
  // joint use of the context is permitted for the
  // applet
  AppletEntry entry = (AppletEntry) JCSystem.getAID( );
  entry.shareContext(applet);
}
```

Referring to FIG. 5, the server applet 14 can implement a security check in step S13 to verify whether the join context request is admissible. A preferred implementation of the security check consists in checking whether a client applet identifier (clientAID) corresponding to the applet object received as a result of the joinContext method call is held in a list of expected applet identifiers, the AIDs.

Optionally, the server applet can, in step S15, erase the instance of the shared interface 20 via which the server applet received the join context request from the client applet, as the instance of the shared interface is needed only to obtain object references from applets, and not for use on an ongoing basis.

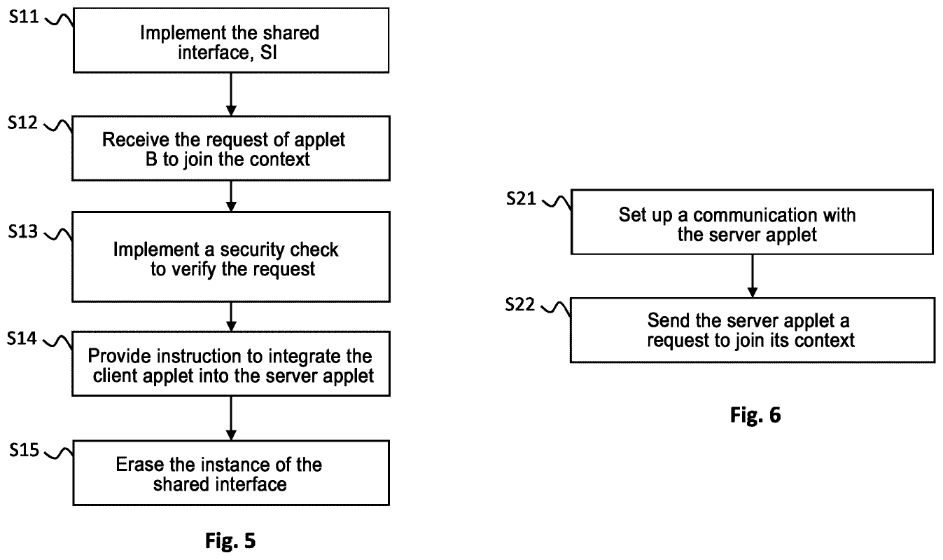

FIG. 6 shows a flowchart for the method according to FIG. 4 as is implemented in a client applet. In a first step S21, the client applet sets up a communication with the server applet by sending a join context notification in order to obtain the shareable interface object (SIO) of the server applet. Preferably, this is implemented by the client applet by calling a method JCSystem.getAppletShareableInterfaceObject(AID serverAID), the parameter serverAID identifying the server applet (for example as implemented in step S7 of FIG. 4).

After the SIO has been obtained by the client applet, said client applet sends a join context request to the server applet in step S22 in order to join the context of said server applet. A preferred implementation of this request consists in the method joinContext being called by the client applet, said method being provided by the server applet via the SIO.

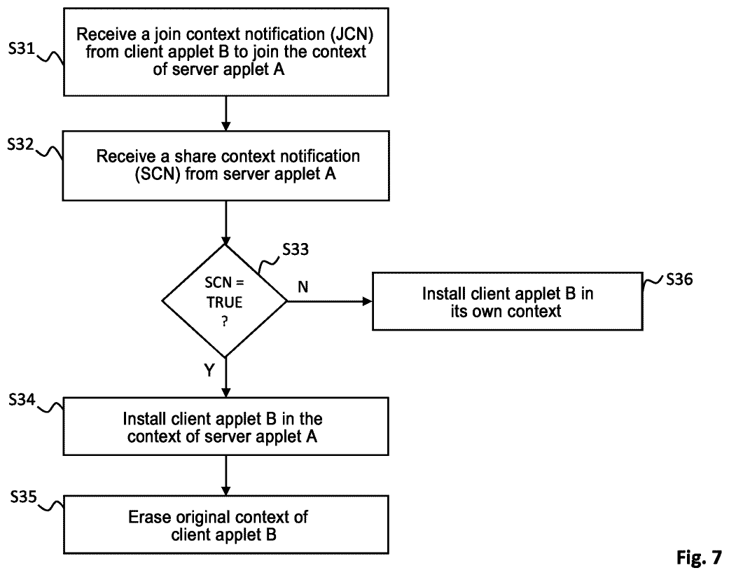

FIG. 7 shows a flowchart for the method according to FIG. 4 as is implemented in the JCRE according to a further embodiment of the invention.

In step S31, the JCRE receives the join context notification (JCN) sent by the client applet in step S22 (FIG. 6). In step S32, the JCRE receives the share context notification (SCN) sent by the server applet in step S14 (FIG. 5). As already mentioned in connection with FIG. 5, the share context notification returns the value “TRUE” or a comparable value, or a value having comparable significance, if shared, or joint, use of the context is permitted, that is to say if the server applet permits the client applet to join its context. Otherwise, “FALSE” or a comparable value, or a value having comparable significance, is returned. The JCRE can therefore check the value of the share context notification, that is to say the value that is returned when the joinContext method is called, in step S33. If this value is “TRUE” or comparable, the JCRE installs the client applet B in the context of the server applet A. If the value is “FALSE” or comparable, the client applet B can be installed in its own context in step S36. Preferably, the original context of the client applet B is erased in step S35 after the client applet B has been installed in the context of the server applet A.

Following installation of the client applet B in the context of the server applet A, the objects of both applets are fully accessible to both applets A and B without the need for further interactions via the shared interface or a change of context, as is the case with conventional solutions. Both the shared interface implemented by the server applet and the original context of the client applet can be erased, and so efficient storage management is possible for the Java Card data carrier.

The aspects and embodiments described here therefore eliminate the disadvantages and limitations that arise as a result of maintaining a shared interface and as a result of the otherwise necessary change of context for the communication between the applets, and afford several advantages, for example:
For smartcard applications, the personalization code added to the context of the target code can simply be erased after personalization. That is to say that the personalization specification package (CPS package) and all of the code relating to the personalization can be removed as soon as all of the personalization steps have concluded. This reduces the storage space requirement on the data carrier, which has only few resources.
The functionality of applets can simply be extended by installing new functions for a specific applet within the existing context.
It is possible to update the code while maintaining the existing data without serialization and deserialization of objects.
The shared context affords an optimized opportunity for joint use by multiple applets. The access is checked only once before the context is joined, and all other accesses take place in the same context with optimized firewall checks.
An access check can be flexibly implemented in the method joinContext( ) in accordance with the security requirements by reusing the shared interface.

In the description above, the invention has been described with reference to specific embodiments and preferably within the framework of software solutions. It has become clear that various modifications and changes can be made without departing from the scope of protection of the invention. The method sequences described above are described with reference to a specific order of the method steps, for example. The order of many of these method steps can be changed, however, without impairing the scope of protection or the manner of operation of the invention. The description and the figures should accordingly be understood to be more illustrative than limiting.

1.-15. (canceled)

16. A method for implementing a context shared between a plurality of applets in a Java Card data carrier, the Java Card data carrier comprising a Java Card runtime environment (JCRE), and a storage device,
wherein at least a first or server applet of the plurality of applets is installed in a first context in the storage device, wherein the method in regard to the server applet comprises:
implementing a shared interface in order to permit a second or client applet to join the context of the server applet;
receiving a request to join the context of the server applet from the client applet via the shared interface; and
instructing the JCRE to integrate the client applet into the first context of the server applet.

17. The method according to claim 16, wherein the shared interface is implemented as a public interface that defines a set of methods that are shared between contexts, and in particular defines a join context method that allows other applets of the plurality of applets to request to join the context of the server applet,
wherein the request to join the context of the server applet is received by way of the call to the join context method, which is parameterized with an applet object of the client applet.

18. The method according to claim 16, further comprising, in regard to the server applet, implementing a security check to verify whether the request to join the context is admissible.

19. The method according to claim 18, wherein the security check comprises a check to ascertain whether a client applet identifier corresponding to the applet object received by way of the call to the join context method is held in a list of admissible applet identifiers, AIDs.

20. The method according to claim 16, wherein the server applet sends a share context notification to the JCRE in order to provide instructions to integrate the client applet into the server applet context.

21. The method according to claim 20, wherein the share context notification is implemented as a system API method that obtains the client applet as input and returns “TRUE” or a value of comparable significance if the request to join the context is admissible, and otherwise returns “FALSE” or a value of comparable significance.

22. The method according to claim 16, further comprising erasing an instance of the shared interface after integration of the client applet into the context of the server applet.

23. A method for implementing a context shared between a plurality of applets in a Java Card data carrier, the Java Card data carrier comprising a Java Card runtime environment (JCRE), and a storage device, wherein at least a first or server applet of the plurality of applets is installed in a first context in the storage device,
wherein the method in regard to a second or client applet of the plurality of applets comprises:
setting up a communication with the server applet via a shared interface that is provided by the server applet; and
sending a request to join the first context of the server applet to the server applet.

24. The method according to claim 23, wherein setup of the communication with the server applet is implemented by sending a join context notification to the JCRE, indicating the server applet whose context the client applet is joining, the join context notification being implemented as a call to a Java Card system method JCSystem.getAppletShareableInterfaceObject (AID serverAID).

25. The method according to claim 23, wherein the client applet sends the request to join the context of the server applet by calling a method that the server applet provides via the shared interface.

26. A method for implementing a context shared between a plurality of applets in a Java Card data carrier, the Java Card data carrier comprising a Java Card runtime environment (JCRE), and a storage device,
wherein at least a first or server applet of the plurality of applets is installed in a first context in the storage device,
wherein the method in regard to the JCRE comprises:
receiving a join context notification from a second or client applet, which notification indicates an applet identifier, AID, of the server applet;
receiving a share context notification from the server applet, wherein the share context notification indicates an AID of the client applet; and
installing the client applet within the first context if the share context notification is “TRUE” or a value of comparable significance.

27. The method according to claim 26, further comprising, if the received share context notification is “FALSE” or a value of comparable significance, installing the client applet in a context of its own.

28. The method according to claim 26, wherein the join context notification of the second applet is received during installation of the second applet or later at the time of execution.

29. A shared interface comprising a set of shared interface methods that a server applet renders accessible to a client applet of a plurality of applets that are loaded in a Java Card data carrier in order to implement a communication between applets,
wherein the shared interface defines a method to be called by the client applet, the method being parameterized with an applet object of the client applet.

30. A computer program product comprising a set of instructions for performing the following steps:
loading a first package, comprising a first applet, onto a Java Card data carrier, the Java Card data carrier comprising a Java Card runtime environment, JCRE, and a storage device;
installing the first applet in a first context in the storage device of the Java Card data carrier;
loading a second package, comprising a second applet, on the Java Card data carrier;
performing the steps according to claim 16 in regard to the first applet;
performing the steps according to a method for the second applet including setting up a communication with the server applet via a shared interface that is provided by the server applet; and sending a request to join the first context of the server applet to the server applet; and
performing the steps according to a method for the JCRE including receiving a join context notification from a second or client applet, which notification indicates an applet identifier, AID, of the server applet; receiving a share context notification from the server applet, wherein the share context notification indicates an AID of the client applet; and installing the client applet within the first context if the share context notification is “TRUE” or a value of comparable significance.
